(19) United States
(12) Patent Application Publication
(10) Pub. No.: US 2021/0139718 A1
(43) Pub. Date: May 13, 2021

(54) STRUCTURAL COLORED INK AND ITS PREPARATION AND USE

(71) Applicants: South China University of Technology, Guangzhou City (CN); The People's Printing Plant of Guangzhou Co.,Ltd., Guangzhou City (CN)

(72) Inventors: Guangxue CHEN, Guangzhou City (CN); Yuhan ZHONG, Guangzhou City (CN); Zhengguo HE, Guangzhou City (CN); Qing WANG, Guangzhou City (CN); Qifeng CHEN, Guangzhou City (CN); Zhixiong SHI, Guangzhou City (CN)

(21) Appl. No.: 17/091,025

(22) Filed: Nov. 6, 2020

(30) Foreign Application Priority Data
Nov. 11, 2019 (CN) 201911096113.5

(51) Int. Cl. C09D 11/037; C09D 11/033; C09D 11/102; C08L 75/04; C08L 91/08; C08K 3/013; C08K 5/05; C08K 5/10; C08K 5/20

(52) U.S. Cl. CPC C09D 11/037; C09D 11/033; C09D 11/102; C08L 75/04; C08K 2201/005; C08K 3/013; C08K 5/05; C08K 5/10; C08K 5/20; C08L 91/08

(57) ABSTRACT

The disclosure provides a structural colored ink and its preparation and use. The ink comprises 10 to 15 wt. % of a pigment, 20 to 40 wt. % of a resin, 50 to 65 wt. % of a solvent, and 2 to 5 wt. % of an auxiliary. The pigment comprises an optically variable pigment and a pearlescent pigment. The resin is at least one selected from a polyurethane resin, an acrylic resin, and a nitrocellulose solution. The solvent is an alcohol, an ester, or a mixed solvent thereof. The ink is alcohol-soluble and environmentally friendly, and has excellent anti-sediment property and stability. Prints made from the ink can have a high color purity, a mild color changing effect, and a color changing and sparkling effect when the viewing angle is changed. So, the ink can have a potential application prospect in screen printing for medium- and high-end packaging products.

### TECHNICAL FIELD

The present disclosure relates generally to the field of inks, and in particular to a structural colored ink, and its preparation method and use.

### BACKGROUND

With the development of economy and advancement of the living standard, the demand for medium- and high-end goods is ever increasing. Along with this, counterfeits, especially in the fields of pharmaceuticals, cosmetics, tobacco, and alcohol, emerge. These counterfeits lead to not only significant economical losses, but also to the risk of physical health of the consumers. To accurately identify the authenticity of a product and to fight against and stop counterfeiting, various anti-counterfeit techniques have been used in industrial production. Among these, pearlescent inks can enhance counterfeit resistance of packaging products and bills, and thus merchant's and consumer's interests can be protected.

CN 105273493 A discloses a gravure pearlescent ink with excellent storage property and a preparation method therefor, the ink comprising a pearlescent pigment, a styrene modified alkyd resin, a maleic acid-acrylic acid-hydroxyethyl acrylate copolymer, and ethyl acetate. CN 103773105 A discloses a pearlescent ink and its preparation, the ink comprising a pearlescent powder, a nitrocellulose resin, a wetting and dispersing agent, an anti-sediment agent, and normal propyl acetate. The inks produced by the methods described in these two patent documents each contain only the pearlescent pigment as a pigment, and thus such inks have no appreciable color changing effect.

Therefore, there exists a need for a structural colored ink which exhibits a more excellent optically variable effect than the pearlescent ink. It is also desired to provide a structural colored ink which allows a print made from the ink to provide an optically variable effect that is adjustable according to the requirements of the print, and which is environmentally friendly, has an improved printability and anti-sediment property, and thus is of significant practical interest and has environmental benefits.

In view of the above, a structural colored ink according to the present disclosure is proposed.

### SUMMARY

A first objective of the present disclosure is to provide a structural colored ink, which comprises an optically variable pigment and a pearlescent pigment. It has been found that prints made from the ink of the disclosure can exhibit a higher color purity, an unique color changing effect, and a noticeable sparkling and color changing effect when the viewing angle is changed. Further, such an ink allows the color changing effect provided by a resulting print to be adjusted based on the requirements of the proof. The disclosed ink is soluble in alcohol and capable of dissolving structural colored pigments well, and is also environmentally friendly. The present ink also has excellent anti-sediment property and stability. Moreover, the ink can enable the resulting prints to have good gloss and strong adhesion.

A second objective of the present disclosure is to provide a method for preparing the structural colored ink as described above. This method is simple, efficient, and environmentally friendly, and can be conducted under mild conditions. So, the present method can be suitable for production on an industrial scale and may have great prospect of application in industrial production.

A third objective of the present disclosure is to provide the use of the structural colored ink as described above in screen printing.

The first objective of the disclosure is realized by a structural colored ink comprising 10 to 15% by weight of a pigment, 20 to 40% by weight of a resin, 50 to 65% by weight of a solvent, and 2 to 5% by weight of an auxiliary;

wherein, the pigment comprises an optically variable pigment and a pearlescent pigment;

the resin is at least one selected from a polyurethane resin, an acrylic resin, and a nitrocellulose solution; and

the solvent is an alcohol, an ester, or a mixed solvent thereof.

Optionally, the structural colored ink may contain no benzene.

Optionally, the resin may be a polyurethane resin.

Optionally, a weight ratio of the pearlescent pigment to the optionally variable pigment may be 1 to 9.

Further, the weight ratio of the pearlescent pigment to the optionally variable pigment may be 1, 2, 3, 4, 5, 6, 7, 8, 9, or a value between any two of the aforementioned values.

Optionally, the optionally variable pigment may have a particle size of 5 to 10 microns. Optionally, the pearlescent pigment may have a particle size of 5 to 100 microns.

Further, the optionally variable pigment may have a particle size of 5, 6, 7, 8, 9, or 10 microns, or a value between any two of the aforementioned values.

The pearlescent pigment may have a particle size of 5, 10, 15, 20, 25, 30, 35, 40, 45, 50, 55, 60, 65, 70, 75, 80, 85, 90, 95, or 100 microns, or a value between any two of the aforementioned values.

The particle sizes of the optionally variable pigment (optionally variable powder) and the pearlescent pigment (pearlescent powder) may have great impact on the printing results given by the structural colored ink. In particular, the pigments with a smaller particle size may enable the final prints to be soft and delicate, while the pigments with a larger particle size may enable the prints to exhibit a sparkling and pearl luster effect.

Optionally, the solvent may be a mixed solvent of an alcohol and an ester.

Further, the alcohol may be at least one selected from ethanol, isopropanol, and cyclohexanone; and the ester may be at least one selected from ethyl acetate, n-propyl acetate, and 2-methoxyethyl acetate.

Further, the solvent may be a mixed solvent of isopropanol and ethyl acetate.

Further, a weight ratio of the isopropanol to the ethyl acetate in the mixed solvent may be 2 to 1. In an embodiment, the solvent is a mixed solvent of an alcohol and an ester, both of which are readily available and environmentally friendly.

Optionally, the auxiliary may comprise 0.5 to 1.5% by weight of an anti-sediment agent, 0.5 to 1.5% by weight of erucylamide, 0.5 to 2% by weight of a defoaming agent, 0.5 to 1% by weight of a polyethylene micronization wax, and 0.5 to 1% by weight of a dispersing agent.

The second aspect of the present disclosure provides a method for preparing the structural colored ink as described above, the method comprising:

adding the resin to a mixture of the pigment and the solvent and mixing until homogeneous, followed by addition of the auxiliary and further homogeneous mixing, so as to obtain the structural colored ink.

Optionally, the mixture of the pigment and the solvent may be formed with stirring. The stirring may be carried out with a stirring speed of 300 to 500 rpm at a temperature of 30 to 35° C. for 2 to 5 hours.

Optionally, the mixing, after the addition of the resin, may be carried out by stirring at a stirring speed of 300 to 500 rpm. The stirring may be carried out for 10 to 60 minutes.

Optionally, the mixing, after the addition of the auxiliary, may be carried out by stirring at a stirring speed of 300 to 500 rpm. The stirring may be carried out for 4 to 6 hours.

According to an embodiment of the present disclosure, the method comprises:

(a) pouring the pigment into a mixed solvent of isopropanol and ethyl acetate slowly to be thoroughly mixed with stirring for 3 hours;
(b) after the pigment and the mixed solvent have been thoroughly mixed, adding the resin thereto and stirring for 30 minutes; and
(c) adding the anti-sediment agent, the erucylamide, the defoaming agent, and the polyethylene micronization wax to the resulting solution from step (b) with stirring to be thoroughly mixed by stirring for 5 hours, so as to obtain the structural colored ink.

According to the third objective of the present disclosure, the use of the structural colored ink as described above in screen printing is provided.

Optionally, for the screen printing, the screen may have a mesh size in a range of 100 to 200 mesh.

Compared with the prior art inks, the structural colored ink according to the present disclosure has several advantages.
The structural colored ink according to the present disclosure comprises an optically variable pigment and a pearlescent pigment in a certain ratio. The optically variable pigment may have a particle size of 5 to 10 microns, and the pearlescent pigment may have a particle size of 5 to 100 microns. The particle sizes of the pigments may have great impact on the printing results given by the structural colored ink. In particular, the pigments with a smaller particle size may enable the final prints to be soft and delicate, while the pigments with a larger particle size may enable the prints to exhibit a sparkling and pearl luster effect. Moreover, the ink of the present disclosure allows the final prints to exhibit an excellent optically variable effect which can be varied as desired, and thus has a high practical value.
The structural colored ink according to the present disclosure is soluble in alcohol and environmentally friendly. Moreover, the ink has excellent anti-sediment property and stability. Further, the ink also allows the resulting prints to have high gloss and adhesion, excellent rub resistance, a high color purity, and a mild color changing effect, and to exhibit a noticeable sparkling and color changing effect when the viewing angle is changed. So, the ink of the disclosure can have a potential application prospect in screen printing for medium- and high-end packaging products.
The method for preparing a structural colored ink according to the present disclosure is simple, efficient, and environmentally friendly, and can be conducted under mild conditions. Performing the method according to the disclosure generally does not require the use of expensive chemical materials or large, complex instruments. The method can be suitable for mass production, and may have great prospect of application in industrial production.

### BRIEF DESCRIPTION OF THE DRAWINGS

In order to describe the present disclosure or the prior art more clearly, drawings referred to in the following description will now be briefly described. Apparently, these drawings are provided merely to illustrate some embodiments of the present disclosure. Other drawings will be, or will become, apparent to those of skill in the art in light of these drawings.

FIG. 1 shows optionally variable effects, at different viewing angles, of a screen-printed pattern obtained using a structural colored ink according to an embodiment of the present disclosure;

FIG. 2 shows optionally variable effects, at different viewing angles, of a screen-printed pattern obtained using a structural colored ink according to another embodiment of the present disclosure;

FIG. 3 shows optionally variable effects, at different viewing angles, of a screen-printed pattern obtained using a structural colored ink according to a further embodiment of the present disclosure;

FIG. 4 shows optionally variable effects, at different viewing angles, of a screen-printed pattern obtained using a structural colored ink according to a yet further embodiment of the present disclosure; and

FIG. 5 shows optionally variable effects, at different viewing angles, of a screen-printed pattern obtained using a structural colored ink according to a further embodiment of the present disclosure;

### DETAILED DESCRIPTION

Exemplary embodiments of the present disclosure will be described below. It should be understood, however, that the exemplary embodiments are provided to further illustrate the present disclosure and not to be taken as limiting the scope of the disclosure. Reaction conditions not indicated in the following exemplary embodiments can be conventional or can be carried out following the manufacturer's recommendations. Reagents or instruments used in the exemplary embodiments without specified manufacturers can be any commercially available ones.

### Example 1

The ingredients for a structural colored ink are listed in Table 1.

TABLE 1
Ingredients for a structural colored ink and amounts thereof

| Ingredients | | Weight percents |
|---|---|---|
| Pigments | Optionally variable pigment | 1% (5 to 10 microns) |
| | Pearlescent pigment | 9% (5 to 100 microns) |

| | |
|---|---|
| Isopropanol | 30% |
| Ethyl acetate | 30% |
| Polyurethane resin | 25% |
| Anti-sediment agent | 1% |
| Erucylamide | 1% |
| Defoaming agent (organo-silicon polymer) | 1% |
| Polyethylene micronization wax | 1% |
| Dispersing agent | 1% |

A structural colored ink was prepared according to the ingredients and the amounts thereof stated in Table 1 as follows.

The structural colored pigments were slowly poured into a mixed solvent of isopropanol and ethyl acetate with stirring to be thoroughly mixed by stirring at a speed of 500 rpm for 3 hours.

After the pigments and the mixed solvent had been thoroughly mixed, the polyurethane resin was added thereto, and stirred with a stirring speed of 500 rpm for 30 minutes.

To the resulting solution, the anti-sediment agent, the erucylamide, the defoaming agent (organo-silicon polymer), and the polyethylene micronization wax were added with stirring to be thoroughly mixed by stirring at a stirring speed of 500 rpm for 5 hours, so that a structural colored ink was obtained. The ink obtained is referred to hereinafter as the Z1^{#} sample.

### Example 2

The ingredients for a structural colored ink are listed in Table 2.

TABLE 2
Ingredients for a structural colored ink and amounts thereof

| Ingredients | | Weight percents |
|---|---|---|
| Pigments | Optionally variable pigment | 2% (5 to 10 microns) |
| | Pearlescent pigment | 9% (5 to 100 microns) |

| | |
|---|---|
| Isopropanol | 28% |
| Ethyl acetate | 30% |
| Polyurethane resin | 25% |
| Anti-sediment agent | 1% |
| Erucylamide | 1% |
| Defoaming agent (organo-silicon polymer) | 1% |
| Polyethylene micronization wax | 1% |
| Dispersing agent | 1% |

A structural colored ink was prepared according to the ingredients and the amounts thereof stated in Table 2 as follows.

The structural colored pigments were slowly poured into a mixed solvent of isopropanol and ethyl acetate with stirring to be thoroughly mixed by stirring at a speed of 500 rpm for 3 hours.

After the pigments and the mixed solvent had been thoroughly mixed, the polyurethane resin was added thereto, and stirred with a stirring speed of 500 rpm for 30 minutes.

To the resulting solution, the anti-sediment agent, the erucylamide, the defoaming agent (organo-silicon polymer), and the polyethylene micronization wax were added with stirring to be thoroughly mixed by stirring at a stirring speed of 500 rpm for 5 hours, so that a structural colored ink was obtained. The ink obtained is referred to hereinafter as the Z2^{#} sample.

### Example 3

The ingredients for a structural colored ink are listed in Table 3.

TABLE 3
Ingredients for a structural colored ink and amounts thereof

| Ingredients | | Weight percents |
|---|---|---|
| Pigments | Optionally variable pigment | 4% (5 to 10 microns) |
| | Pearlescent pigment | 8% (5 to 100 microns) |

| | |
|---|---|
| Isopropanol | 27% |
| Ethyl acetate | 30% |
| Polyurethane resin | 25% |
| Anti-sediment agent | 1% |
| Erucylamide | 1% |
| Defoaming agent (organo-silicon polymer) | 1% |
| Polyethylene micronization wax | 1% |
| Dispersing agent | 1% |

A structural colored ink was prepared according to the ingredients and the amounts thereof stated in Table 3 as follows.

The structural colored pigments were slowly poured into a mixed solvent of isopropanol and ethyl acetate with stirring to be thoroughly mixed by stirring at a speed of 500 rpm for 3 hours.

After the pigments and the mixed solvent had been thoroughly mixed, the polyurethane resin was added thereto, and stirred with a stirring speed of 500 rpm for 30 minutes.

To the resulting solution, the anti-sediment agent, the erucylamide, the defoaming agent (organo-silicon polymer), and the polyethylene micronization wax were added with stirring to be thoroughly mixed by stirring at a stirring speed of 500 rpm for 5 hours, so that a structural colored ink was obtained. The ink obtained is referred to hereinafter as the Z3^{#} sample.

### Example 4

The ingredients for a structural colored ink are listed in Table 4.

TABLE 4
Ingredients for a structural colored ink and amounts thereof

| Ingredients | | Weight percents |
|---|---|---|
| Pigments | Optionally variable pigment | 6% (5 to 10 microns) |
| | Pearlescent pigment | 8% (5 to 100 microns) |

| | |
|---|---|
| Isopropanol | 26% |
| Ethyl acetate | 30% |
| Polyurethane resin | 25% |
| Anti-sediment agent | 1% |
| Erucylamide | 1% |
| Defoaming agent (organo-silicon polymer) | 1% |
| Polyethylene micronization wax | 1% |
| Dispersing agent | 1% |

A structural colored ink was prepared according to the ingredients and the amounts thereof stated in Table 4 as follows.

The structural colored pigments were slowly poured into a mixed solvent of isopropanol and ethyl acetate with stirring to be thoroughly mixed by stirring at a speed of 500 rpm for 3 hours.

After the pigments and the mixed solvent had been thoroughly mixed, the polyurethane resin was added thereto, and stirred with a stirring speed of 500 rpm for 30 minutes.

To the resulting solution, the anti-sediment agent, the erucylamide, the defoaming agent (organo-silicon polymer), and the polyethylene micronization wax were added with stirring to be thoroughly mixed by stirring at a stirring speed of 500 rpm for 5 hours, so that a structural colored ink was obtained. The ink obtained is referred to hereinafter as the Z4^{#} sample.

### Example 5

The ingredients for a structural colored ink are listed in Table 5.

TABLE 5
Ingredients for a structural colored ink and amounts thereof

| Ingredients | | Weight percents |
|---|---|---|
| Pigments | Optionally variable pigment | 7.5% (5 to 10 microns) |
| | Pearlescent pigment | 7.5% (5 to 100 microns) |

| | |
|---|---|
| Isopropanol | 25% |
| Ethyl acetate | 30% |
| Polyurethane resin | 25% |
| Anti-sediment agent | 1% |
| Erucylamide | 1% |
| Defoaming agent (organo-silicon polymer) | 1% |
| Polyethylene micronization wax | 1% |
| Dispersing agent | 1% |

A structural colored ink was prepared according to the ingredients and the amounts thereof stated in Table 5 as follows.

The structural colored pigments were slowly poured into a mixed solvent of isopropanol and ethyl acetate with stirring to be thoroughly mixed by stirring at a speed of 500 rpm for 3 hours.

After the pigments and the mixed solvent had been thoroughly mixed, the polyurethane resin was added thereto, and stirred with a stirring speed of 500 rpm for 30 minutes.

To the resulting solution, the anti-sediment agent, the erucylamide, the defoaming agent (organo-silicon polymer), and the polyethylene micronization wax were added with stirring to be thoroughly mixed by stirring at a stirring speed of 500 rpm for 5 hours, so that a structural colored ink was obtained. The ink obtained is referred to hereinafter as the Z5^{#} sample.

### Example 6

The ingredients for a structural colored ink are listed in Table 6.

TABLE 6
Ingredients for a structural colored ink and amounts thereof

| Ingredients | | Weight percents |
|---|---|---|
| Pigments | Optionally variable pigment | 6.5% (5 to 10 microns) |
| | Pearlescent pigment | 6.5% (5 to 100 microns) |

| | |
|---|---|
| Isopropanol | 27% |
| Ethyl acetate | 25% |
| Polyurethane resin | 30% |
| Anti-sediment agent | 1% |
| Erucylamide | 1% |
| Defoaming agent (organo-silicon polymer) | 1% |
| Polyethylene micronization wax | 1% |
| Dispersing agent | 1% |

A structural colored ink was prepared according to the ingredients and the amounts thereof stated in Table 6 as follows.

The structural colored pigments were slowly poured into a mixed solvent of isopropanol and ethyl acetate with stirring to be thoroughly mixed by stirring at a speed of 500 rpm for 3 hours.

After the pigments and the mixed solvent had been thoroughly mixed, the polyurethane resin was added thereto, and stirred with a stirring speed of 500 rpm for 30 minutes.

To the resulting solution, the anti-sediment agent, the erucylamide, the defoaming agent (organo-silicon polymer), and the polyethylene micronization wax were added with stirring to be thoroughly mixed by stirring at a stirring speed of 500 rpm for 5 hours, so that a structural colored ink was obtained. The ink obtained is referred to hereinafter as the Z6^{#} sample.

### Example 7

The ingredients for a structural colored ink are listed in Table 7.

TABLE 7
Ingredients for a structural colored ink and amounts thereof

| Ingredients | | Weight percents |
|---|---|---|
| Pigments | Optionally variable pigment | 6.5% (5 to 10 microns) |
| | Pearlescent pigment | 6.5% (5 to 100 microns) |

| | |
|---|---|
| Isopropanol | 27% |
| Ethyl acetate | 20% |
| Polyurethane resin | 35% |
| Anti-sediment agent | 1% |
| Erucylamide | 1% |
| Defoaming agent (organo-silicon polymer) | 1% |
| Polyethylene micronization wax | 1% |
| Dispersing agent | 1% |

A structural colored ink was prepared according to the ingredients and the amounts thereof stated in Table 3 as follows.

The structural colored pigments were slowly poured into a mixed solvent of isopropanol and ethyl acetate with stirring to be thoroughly mixed by stirring at a speed of 500 rpm for 3 hours.

After the pigments and the mixed solvent had been thoroughly mixed, the polyurethane resin was added thereto, and stirred with a stirring speed of 500 rpm for 30 minutes.

To the resulting solution, the anti-sediment agent, the erucylamide, the defoaming agent (organo-silicon polymer), and the polyethylene micronization wax were added with stirring to be thoroughly mixed by stirring at a stirring speed of 500 rpm for 5 hours, so that a structural colored ink was obtained. The ink obtained is referred to hereinafter as the Z7^{#} sample.

### Example 8

The ingredients for a structural colored ink are listed in Table 8.

TABLE 8
Ingredients for a structural colored ink and amounts thereof

| Ingredients | | Weight percents |
|---|---|---|
| Pigments | Optionally variable pigment | 6.5% (5 to 10 microns) |
| | Pearlescent pigment | 6.5% (5 to 100 microns) |

| | |
|---|---|
| Isopropanol | 27% |
| Ethyl acetate | 15% |
| Polyurethane resin | 40% |
| Anti-sediment agent | 1% |
| Erucylamide | 1% |
| Defoaming agent (organo-silicon polymer) | 1% |
| Polyethylene micronization wax | 1% |
| Dispersing agent | 1% |

A structural colored ink was prepared according to the ingredients and the amounts thereof stated in Table 8 as follows.

The structural colored pigments were slowly poured into a mixed solvent of isopropanol and ethyl acetate with stirring to be thoroughly mixed by stirring at a speed of 500 rpm for 3 hours.

After the pigments and the mixed solvent had been thoroughly mixed, the polyurethane resin was added thereto, and stirred with a stirring speed of 500 rpm for 30 minutes.

To the resulting solution, the anti-sediment agent, the erucylamide, the defoaming agent (organo-silicon polymer), and the polyethylene micronization wax were added with stirring to be thoroughly mixed by stirring at a stirring speed of 500 rpm for 5 hours, so that a structural colored ink was obtained. The ink obtained is referred to hereinafter as the Z8^{#} sample.

### Test Example 1: Performance Characterization of the Structural Colored Inks

The ink samples in Examples 1 to 8 each were tested using an X-Rite spectrophotometer, a Navo-Gloss glossmeter, a NDJ-79 rotary viscometer, and a 3M adhesive tape. Five points were randomly selected on each sample and were subjected to the tests. Test results for the five points on each sample were averaged and listed in Table 9.

TABLE 9
Performances of structural colored inks

| Sample No. | | Z1^{#} | Z2^{#} | Z3^{#} | Z4^{#} | Z5^{#} | Z6^{#} | Z7^{#} | Z8^{#} |
|---|---|---|---|---|---|---|---|---|---|
| Solid content | | 37% | 39% | 40% | 41% | 42% | 42% | 47% | 52% |
| Chroma | L | 49.24 | 56.11 | 63.584 | 57.768 | 46.24 | 48.92 | 54.15 | 65.238 |
| | a | −11.56 | −12.472 | −11.924 | −12.502 | −10.41 | −11.34 | −11.77 | −12.116 |
| | b | 16.306 | 17.326 | 17.438 | 17.958 | 14.82 | 15.48 | 17.82 | 16.534 |

| | | | | | | | | |
|---|---|---|---|---|---|---|---|---|
| Color density | 0.914 | 0.816 | 0.616 | 0.768 | 0.582 | 0.97 | 0.92 | 0.86 |
| Gloss (75°) | 47.9 | 41.7 | 35.68 | 33.16 | 30.98 | 47.86 | 50.312 | 58.32 |
| Viscosity (mp · s) | 204 | 221.4 | 210 | 209 | 235 | 425.6 | 745.8 | 772 |
| | No | No | No | No | No | No | No | No |
| Adhesion | peeling of | peeling of | peeling of | peeling of | peeling of | peeling of | peeling of | peeling of |
| (with 3M adhesive | 99.98% of | 99.95% of | 99.96% of | 99.99% of | 99.99% of | 99.98% of | 99.99% of | 99.98% of |
| tape applied 3 times) | the ink was | the ink was | the ink was | the ink was | the ink was | the ink was | the ink was | the ink was |
| | observed. | observed. | observed. | observed. | observed. | observed. | observed. | observed. |
| Dryness | Complete | Complete | Complete | Complete | Complete | Complete | Complete | Complete |

The results of Table 9 showed that the brightness and viscosity of the sample increased as the amount of the structural colored pigments increased, and the gloss decreased as the amount of the pigments increased due to the fact that the pigments themselves had a large particle size. The results also showed that the ink had a strong adhesion to a substrate and a good drying characteristic.

In addition, the gloss and viscosity of the sample increased as the amount of the resin increased. When the resin amount was higher than 30%, the ink would be difficult to penetrate through a screen while performing the screen printing. So, the resin amount should be appropriately lowered.

### Test Example 2: Effects of Amounts of the Pearlescent and Optically Variable Pigments on Chroma Provided by the Ink Samples

The Z1^{#}-Z5^{#} samples were photographed using a camera at angles of zero and 45 degrees. Five points were selected on the sample pictures and were subjected to color measurement using a Photoshop software to obtain Lab values, which were then averaged. Chromatic aberrations were then calculated based on the averaged Lab values for the various samples so as to make a comparison. The results were shown in Table 10.

TABLE 10
Effects of amounts of the pearlescent and optically variable pigments on chroma provided by the ink samples

| | Pearlescent/optically variable pigments | | | | | | | | | | | | | | |
|---|---|---|---|---|---|---|---|---|---|---|---|---|---|---|---|
| | Z1^{#} | | | Z2^{#} | | | Z3^{#} | | | Z4^{#} | | | Z5^{#} | | |
| Chromatic values | L | a | b | L | a | b | L | a | b | L | a | b | L | a | b |
| 0° | 60 | −33 | −5 | 60 | −29 | −8 | 61 | −26 | −12 | 59 | −22 | −18 | 60 | −24 | −18 |
| 45° | 43 | 21 | −6 | 48 | 18 | −4 | 47 | 16 | −2 | 38 | 16 | −3 | 40 | 16 | −4 |

| | | | | | |
|---|---|---|---|---|---|
| Chromatic aberrations | 57.0964 | 49.163 | 45.3872 | 45.9347 | 46.8615 |
| Optically variable | Excellent | Sparkling effect | Good optically | Good optically | Good optically |
| effect (visual) | optically variable | and excellent | variable effect | variable effect | variable effect |
| | effect, but poor | optically | and good | and good | and good |
| | sparkling effect | variable effect | sparkling effect | sparkling effect | sparkling effect |

The results of Table 10 showed that as the amount of the pearlescent pigment increased, the chromatic aberration gradually decreased, and the optically variable effect became milder. In addition, the sample became more shiny as the amount of the pearlescent pigment increased.

### Test Example 3: Printing of Proofs by Using Inks with Different Pearlescent and Optically Variable Pigments

Screen printing was carried out by using the Z6^{#} sample in Example 6 to test the printability of the ink sample.

A screen printing unit was employed to perform the printing on a piece of black matte card paper (printing substrate) at a printing speed of 6 meters per minute. The screen had a mesh size of 180 mesh. An optionally variable pigment was mixed with a color changing pearlescent pigment and a monochrome pearlescent pigment with different particle sizes to form a structural colored pigment. Resulting preferred proofs were shown in Table 11.

As shown in Table 11, the term “optionally variable pigment 1” referred to an optionally variable pigment having a particle size of 5 microns; the term “optionally variable pigment 2” referred to an optionally variable pigment having a particle size of 10 microns; and, the term “optionally variable pigment 3” referred to an optionally variable pigment having a particle size of 8 microns. The term “pearlescent pigment 1” referred to a pearlescent pigment having a particle size of 25 microns; the term “pearlescent pigment 2” referred to a pearlescent pigment having a particle size of 40 microns; the term “pearlescent pigment 3” referred to a pearlescent pigment having a particle size of 60 microns; and the term “pearlescent pigment 4” referred to a pearlescent pigment having a particle size of 100 microns.

TABLE 11
Proofs printed using mixtures of different pearlescent
and optionally variable pigments

| Proof | | |
|---|---|---|
| No. | Pigments | Effects (from different viewing angles) |
| 1 | Optionally variable pigment 1 + | Three mild color changing effects; and |
| | pearlescent pigment 1 | excellent sparkling effect (FIG. 1) |
| 2 | Optionally variable pigment 1 + | Three mild color changing effects; and |
| | pearlescent pigment 2 | excellent sparkling effect (FIG. 2) |
| 3 | Optionally variable pigment 2 + | Two color changing effects with significant |
| | pearlescent pigment 1 | contrast; and excellent sparkling effect (FIG. 3) |
| 4 | Optionally variable pigment 2 + | Two color changing effects with significant |
| | pearlescent pigment 3 | contrast; and excellent sparkling effect (FIG. 4) |
| 5 | Optionally variable pigment 3 + | Two color changing effects with significant |
| | pearlescent pigment 4 | contrast; and excellent sparkling effect (FIG. 5) |

As seen in FIGS. 1 to 5, when an optionally variable pigment was mixed with a monochrome pearlescent pigment, three mild color changing effects or a sparkling effect occurred, which followed the color material mixing law. Similarly, when an optionally variable pigment was mixed with a color changing pearlescent pigment, three mild color changing effects or a sparkling effect occurred, which followed the color material mixing law. Moreover, when the color systems seen from the same viewing angle were the same, the color changing effect can be enhanced. So, a structural colored ink presenting a particular color changing effect can be produced by mixing the optically variable pigment and the pearlescent pigment in a certain ratio.

It was also found that the ink exhibited a good stability during the screen printing process, and the resulting proofs can be dried completely on the printing spot and provided clear print with a noticeable pearlescent effect. Further, the resulting print was well resistant to rub and chemical corrosion.

Finally, it is noted that the above embodiments are provided merely for purposes of illustration and are not intended to limit the scope of the disclosure. Although the embodiments of the disclosure have been described in detail, it should be understood that various modifications and equivalents may be made hereto without departing from the scope of the disclosure.

What is claimed is:

1. A structural colored ink, comprising:
10 to 15% by weight of a pigment;
20 to 40% by weight of a resin;
50 to 65% by weight of a solvent; and
2 to 5% by weight of an auxiliary;
wherein, the pigment comprises an optically variable pigment and a pearlescent pigment;
the resin is at least one selected from a polyurethane resin, an acrylic resin, and a nitrocellulose solution; and
the solvent is an alcohol, an ester, or a mixed solvent thereof.

2. The structural colored ink according to claim 1, wherein, a weight ratio of the pearlescent pigment to the optionally variable pigment is from 1 to 9;
and wherein, the optionally variable pigment has a particle size of 5 to 10 microns, and the pearlescent pigment has a particle size of 5 to 100 microns.

3. The structural colored ink according to claim 1, wherein, the solvent is a mixed solvent of an alcohol and an ester;
preferably, the alcohol is at least one selected from ethanol, isopropanol, and cyclohexanone;
and preferably, the ester is at least one selected from ethyl acetate, n-propyl acetate, and 2-methoxyethyl acetate;
further preferably, the solvent is a mixed solvent of isopropanol and ethyl acetate, wherein, a weight ratio of the isopropanol to the ethyl acetate in the mixed solvent is from 2 to 1.

4. The structural colored ink according to claim 1, wherein, the resin is a polyurethane resin.

5. The structural colored ink according to claim 1, wherein, the auxiliary comprises 0.5 to 1.5% by weight of an anti-sediment agent, 0.5 to 1.5% by weight of erucylamide, 0.5 to 2% by weight of a defoaming agent, 0.5 to 1% by weight of a polyethylene micronization wax, and 0.5 to 1% by weight of a dispersing agent.

6. A method for preparing the structural colored ink according to claim 1, the method comprising:
adding the resin to a mixture of the pigment and the solvent and mixing until homogeneous, followed by addition of the auxiliary and further homogeneous mixing, so as to obtain the structural colored ink.

7. A method for preparing the structural colored ink according to claim 2, the method comprising:
adding the resin to a mixture of the pigment and the solvent and mixing until homogeneous, followed by addition of the auxiliary and further homogeneous mixing, so as to obtain the structural colored ink.

8. A method for preparing the structural colored ink according to claim 3, the method comprising:
adding the resin to a mixture of the pigment and the solvent and mixing until homogeneous, followed by addition of the auxiliary and further homogeneous mixing, so as to obtain the structural colored ink.

9. A method for preparing the structural colored ink according to claim 4, the method comprising:
adding the resin to a mixture of the pigment and the solvent and mixing until homogeneous, followed by addition of the auxiliary and further homogeneous mixing, so as to obtain the structural colored ink.

10. A method for preparing the structural colored ink according to claim 5, the method comprising:
adding the resin to a mixture of the pigment and the solvent and mixing until homogeneous, followed by addition of the auxiliary and further homogeneous mixing, so as to obtain the structural colored ink.

11. The method according to claim 6, wherein, the mixture of the pigment and the solvent is formed with stirring, wherein the stirring is carried out with a stirring speed of 300 to 500 rpm at a temperature of 30 to 35° C. for 2 to 5 hours.

12. The method according to claim 7, wherein, the mixture of the pigment and the solvent is formed with stirring, wherein the stirring is carried out with a stirring speed of 300 to 500 rpm at a temperature of 30 to 35° C. for 2 to 5 hours.

13. The method according to claim 8, wherein, the mixture of the pigment and the solvent is formed with stirring, wherein the stirring is carried out with a stirring speed of 300 to 500 rpm at a temperature of 30 to 35° C. for 2 to 5 hours.

14. The method according to claim 9, wherein, the mixture of the pigment and the solvent is formed with stirring, wherein the stirring is carried out with a stirring speed of 300 to 500 rpm at a temperature of 30 to 35° C. for 2 to 5 hours.

15. The method according to claim 10, wherein, the mixture of the pigment and the solvent is formed with stirring, wherein the stirring is carried out with a stirring speed of 300 to 500 rpm at a temperature of 30 to 35° C. for 2 to 5 hours.

16. The method according to claim 6, wherein, the mixing, after the addition of the resin, is carried out by stirring, wherein the stirring is carried out with a stirring speed of 300 to 500 rpm for 10 to 60 minutes.

17. The method according to claim 7, wherein, the mixing, after the addition of the resin, is carried out by stirring, wherein the stirring is carried out with a stirring speed of 300 to 500 rpm for 10 to 60 minutes.

18. The method according to claim 8, wherein, the mixing, after the addition of the resin, is carried out by stirring, wherein the stirring is carried out with a stirring speed of 300 to 500 rpm for 10 to 60 minutes.

19. The method according to claim 6, wherein, the mixing, after the addition of the auxiliary, is carried out by stirring, wherein the stirring is carried out with a stirring speed of 300 to 500 rpm for 4 to 6 hours.

20. Use of the structural colored ink according to claim 1 in screen printing, preferably using a 100 to 200 mesh screen.
